(19) United States
(12) Patent Application Publication
(10) Pub. No.: US 2026/0029911 A1
(43) Pub. Date: Jan. 29, 2026

(54) DATA REFRESH OF A DATA STRIPE OF A VIRTUAL BLOCK

(71) Applicant: Microchip Technology Incorporated, Chandler, AZ (US)

(72) Inventors: Pitamber SHUKLA, San Jose, CA (US); Chris NORRIE, Castro Valley, CA (US); Nian Niles YANG, Mountain View, CA (US); Srinivas YELISETTI, Fremont, CA (US)

(21) Appl. No.: 19/031,470

(22) Filed: Jan. 18, 2025

Related U.S. Application Data
(60) Provisional application No. 63/676,329, filed on Jul. 26, 2024.

(51) Int. Cl. G06F 3/06

(52) U.S. Cl. CPC G06F 3/0604; G06F 3/0655; G06F 3/0665; G06F 3/0679

(57) ABSTRACT

In some implementations, a controller may detect a read error associated with data obtained based on a request from a host device. The controller may identify a data frame, of a virtual block, that stores the data. The controller may perform scan operations or host read operations on the virtual block. The controller may determine whether the read error is localized to less than a portion of the virtual block, based on performing the scan operations or the host read operations. The controller may perform a data refresh of a data stripe of the virtual block based on determining whether the read error is localized to less than the portion of the virtual block, wherein the data stripe includes the data, and wherein the data refresh is performed without performing a data refresh of other data stripes of the virtual block.

### CROSS-REFERENCE TO RELATED APPLICATION

This Patent Application claims priority to Provisional Patent Application No. 63/676,329, filed on Jul. 26, 2024, and entitled “DATA REFRESH OF A DATA STRIPE OF A VIRTUAL BLOCK.” The disclosure of the prior Application is considered part of and is incorporated by reference into this Patent Application.

### FIELD

The present disclosure generally relates to performing data refresh of a virtual block and, for example, to mitigating the Uncorrectable Bit Error Rate (UBER) using data tracking logs for reclaimed virtual blocks.

### BACKGROUND

A non-volatile memory device may include a storage device that may store and retain data without external power supply. One example of a storage device is a NOT-AND (NAND) flash memory device. A solid state drive (SSD) may include multiple non-volatile memory devices. A non-volatile memory device (or a die of the non-volatile memory device) may include multiple planes. A plane may include multiple blocks and a block may include multiple wordline. A wordline may include one or more pages.

In some situations, the multiple non-volatile memory devices (or dies of the multiple non-volatile memory devices) may form a virtual block (VB). The VB is a collection of blocks (e.g., memory blocks) across all logical unit numbers (LUNs). A VB has a size that varies according to number of bad blocks. For example, if no bad blocks, the size=(#Channels)×(#Targets)×(#LUNs)×(Physical Block Size). The VB includes multiple virtual pages. A virtual page is a collection of pages across all LUNs in a VB.

Typically, a reliability of the SSD decreases as the age, of the non-volatile memory device, increases. The decrease in reliability leads to an increase in read errors.

### SUMMARY

A method comprising: detecting a read error associated with data obtained based on a request from a host device; identifying a data frame, of a virtual block, that stores the data; performing scan operations or host read operations on the virtual block; determining whether the read error is localized to less than a portion of the virtual block, based on performing the scan operations or the host read operations; and performing a data refresh of a data stripe of the virtual block based on determining whether the read error is localized to less than the portion of the virtual block, wherein the data stripe includes the data, and wherein the data refresh is performed without performing a data refresh of other data stripes of the virtual block.

A system comprising: a controller to: detect a read error associated with data obtained based on a request from a host device, wherein the data is stored in a virtual block; perform scan operations or host read operations on the virtual blocks; determine whether the data, associated with the read error, is stored in less than a portion of the virtual block, based on performing the scan operations or the host read operations; and perform a data refresh of a data stripe of the virtual block based on determining whether the data is stored in less than the portion of the virtual block, wherein the portion of the virtual block includes the data stripe, and wherein the data refresh is performed without performing a data refresh of other data stripes of the virtual block.

A non-transitory computer-readable medium storing a set of instructions, the set of instructions comprising: one or more instructions that, when executed by one or more processors of a controller, cause the controller to: detect a read error associated with data obtained based on a request from a host device; identify a data frame, of a virtual block, that stores the data; perform scan operations or host read operations on the virtual block; determine whether the read error is localized to less than a portion of the virtual block, based on performing the scan operations or the host read operations; and perform a data refresh of a data stripe of the virtual block based on determining whether the read error is localized to less than the portion of the virtual block, wherein the data d stripe includes the data, and wherein the data refresh is performed without performing a data refresh of other data stripes of the virtual block.

### BRIEF DESCRIPTION OF THE DRAWINGS

FIG. 1 is a block diagram showing an example of a solid state drive (SSD), in accordance with the present disclosure.

FIG. 2 is a block diagram showing another example of an SSD, in accordance with the present disclosure.

FIGS. 3A and 3B are diagrams illustrating examples of an impact on NAND cell reliability from multiple erase-program operations, in accordance with the present disclosure.

FIG. 4 is a diagram illustrating an example of a read error in a partially-filled virtual block (VB), in accordance with the present disclosure.

FIG. 5 is a flow chart showing an example of a process associated with performing a selective data refresh operation of a data stripe of a VB, in accordance with the present disclosure.

FIG. 6 is a flow chart showing another example of a process associated with performing a selective data refresh operation of a data stripe of a VB, in accordance with the present disclosure.

### DETAILED DESCRIPTION

The following detailed description of example implementations refers to the accompanying drawings. The same reference numbers in different drawings may identify the same or similar elements.

A solid state drive (SSD) may provide data regarding the SSD to a host device associated with the SSD. An SSD may include multiple non-volatile memory devices. The multiple non-volatile memory devices (or dies of the multiple non-volatile memory devices) may form a virtual block (VB). The VB is a collection of blocks (e.g., memory blocks) across multiple logical unit numbers (LUNs).

Blocks, in the VB, may have the same program/erase (P/E) cycles. A controller of the SSD may maintain separate pools of VBs for user data and system data. System data may be stored on single-level cell (SLC) blocks due to the high reliability requirement for the system data whereas user data may be stored on triple-level cell (TLC) blocks. Some blocks may be reserved per die to be replacements for bad blocks.

Typically, a reliability of the SSD decreases as the age of the non-volatile memory device increases. The decrease in reliability leads to an increase in read errors.

Currently, a system firmware (FW) issues a complete data refresh of a VB in case a particular physical block, within a VB, experiences a read error. During a complete data refresh operation, an entirety of data on the VB may be moved to another VB. The existing FW solution is prone to write amplification and open block erase. Therefore, the existing FW solution can significantly reduce the life of the SSD.

Performing a complete data refresh, with the occurrence of a read error, introduces write amplification. Additionally, the data move from one VB to another VB introduces additional P/E cycles. The additional P/E cycles may degrade cell reliability and, therefore, may reduce life of the SSD.

Performing a complete data refresh operation on an entire VB significantly increases write amplification due to transferring of valid data from a current VB (that has experience on read error) to a new VB without monitoring an overall health of the current VB. In other words, the valid data may be transferred without monitoring a subsequent read status (part of host read and/or scan read) of the current VB.

Write amplification may increase P/E cycles on the block which degrades cell intrinsic reliability and, therefore, limit the life of the SSD. Additionally, write amplification may decrease write throughput and may increase write latencies. Furthermore, write amplification may significantly increase read latency in mixed workload.

Read error may occur in a VB in an open state. The VB may be a VB with a certain percentage of physical locations with valid data. Therefore, a current algorithm of the system FW may be more prone for an open block erase. An open block erase may cause deep erase on unprogrammed wordlines and may cause shallow erase on programmed wordlines.

Implementations described herein are directed to a technical solution to the technical problem of write amplification caused by a complete data refresh operation of a VB. In this regard, the technical solution includes performing a selective VB data stripe refresh instead of a complete VB data refresh to address read errors. Performing the selective VB data strip refresh as described herein significantly reduces write amplification and avoids unnecessary open block erase. Reducing writing amplification and avoiding unnecessary open block erase may enhance a lifetime of the SSD and may improve quality of service (QoS) of the SSD.

As used herein, a “data stripe” may be used to refer to a portion of data stored on a block (e.g., a memory block). In some examples, a data stripe may include one or more wordlines. In some examples, a data stripe may include a portion of a wordline. In some aspects, a data stripe may be a redundant array of independent disks (RAID) stripe. In this regard, a “data stripe refresh” may be used to refer to a data refresh of a portion of a block, as opposed to a complete data refresh (e.g., a data refresh of an entire block or of an entire VB).

Implementations described herein are directed to an algorithm for performing selective refresh of a particular data stripe, of a VB, based on the read error occurrence and monitoring the rest of the VB data stripes in the VB during subsequent host/scan reads to decide if a complete data refresh, of the VA, is to be performed. In this regard, implementations described herein are directed to a system FW based monitoring that will avoid unnecessary complete data refreshes and reduce P/E cycles, thereby improving the lifetime of the SSD.

Implementations described herein are directed to including a VB, experiencing a read error, in a monitoring pool of VBs (e.g., a pool of monitored VBs). Based on results of host read and/or scan read, the system FW will adaptively determine whether to perform a data stripe refresh operation or a complete data refresh operation.

Implementations described herein provide a technical solution with multiple technical advantages. For example, implementations described herein reduce write amplification due to read errors by avoiding a complete VB data refresh by performing only selective data stripe refresh. Additionally, implementations described herein avoid unnecessary increase of P/E cycles of the VB and enhance a life of the SSD.

Furthermore, implementations described herein avoid open block erase conditions, if possible, to enhance reliability of the SSD, thereby reducing further errors. Implementations described are directed to continuing to write user data on read errored open VBs. The user data may be written (or programmed) using the system FW solution (e.g., an adaptive system FW solution). The system FW solution may be implemented using scan reads. In this regard, implementations described herein will avoid redundant garbage collection and, therefore, will significantly reduce concern of effective over-provisioning (OP).

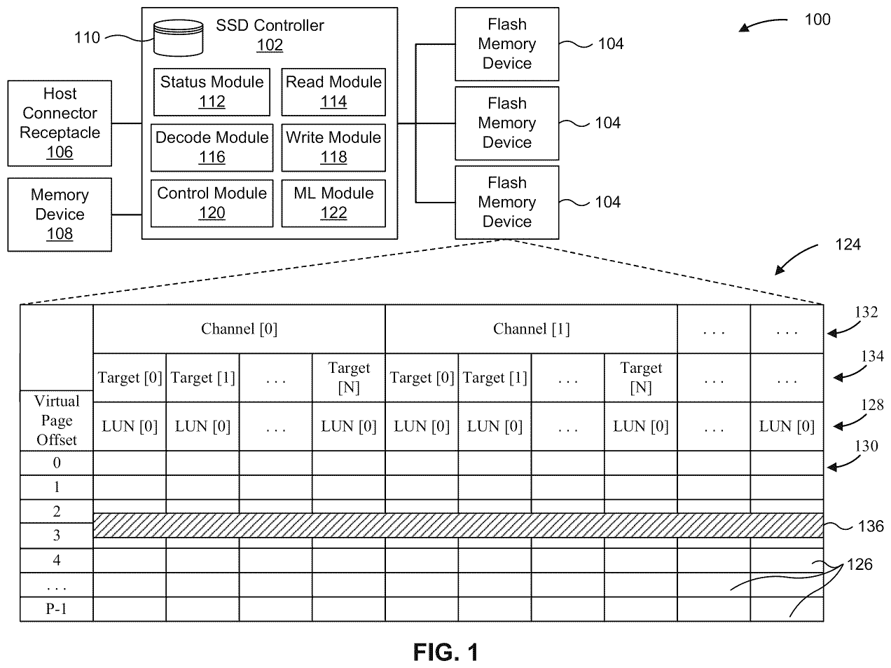

FIG. 1 is a block diagram showing an example of an SSD 100, in accordance with the present disclosure. SSDs may use standard read instructions (e.g., READ or READ PAGE instruction) to perform a read of a memory cell at a default threshold voltage within each threshold voltage region required to define a bit of the memory cell. Single Level Cell (SLC) flash memory devices store a single bit of information in each cell and only require a read in a single threshold voltage region (the threshold voltage region is the region that extends between the center of the voltage distribution for a 1 and the center of the voltage distribution for a 0) to identify the value of a bit (whether the cell is storing a 1 or a 0). Multi-level cell (MLC) flash memory devices store two bits of information in each cell, triple level cell (TLC) flash memory devices store three bits of information in each cell, quad level cell (QLC) flash memory devices store four bits of information in each cell and penta level cell (PLC) flash memory devices store five bits of information in each cell.

Some SSD's use threshold-voltage-shift reads for reading flash memory devices to obtain low levels of Uncorrectable Bit Error Rate (UBER) required for client and enterprise SSD's. Threshold-voltage-shift reads are performed by sending a threshold-voltage-shift read instruction to a flash memory device that is to be read. One or more threshold-Voltage-Shift Offset (TVSO) value is sent with the threshold-voltage-shift read instruction. The TVSO value indicates the amount by which the threshold voltage that is used to perform the read is to be offset from a corresponding default threshold voltage that is specified by the manufacturer of the flash memory device. Threshold-voltage-shift read instructions for MLC, TLC, QLC and PLC flash memory devices require that multiple TVSO values be sent to the flash memory device in order to perform each read.

The SSD 100 is shown in FIG. 1 to include an SSD controller 102 coupled to a plurality of flash memory devices 104 for storing data. In some embodiments, the flash memory devices 104 are NAND devices and the SSD 100 includes one or more circuit boards onto which a host connector receptacle 106, the SSD controller 102, and the flash memory devices 104 are attached. The SSD 100 may also include one or more memory devices 108, such as a Dynamic Random Access Memory (DRAM), that may be a separate integrated circuit device attached to the one or more circuit boards, and is electrically coupled to the SSD controller 102.

The SSD controller 102 is configured to receive read and write instructions from a host computer through the host connector receptacle 106, and to perform program operations, erase operations, and read operations on memory cells of flash memory devices 104 to complete the instructions from the host computer. For example, upon receiving a write instruction from the host computer via host connector receptacle 106, the SSD controller 102 is operable to store data in the SSD 100 by performing program operations (and when required, erase operations) to program codewords into on one or more flash memory devices 104. As used herein, a codeword may refer to information that may be used to encode and correct errors in data stored on one or more flash memory devices 104.

The SSD controller 102 includes a data storage module 110, a status module 112, a read module 114, a decode module 116, a write module 118, a control module 120, and an ML module 122. The control module 120 may be coupled to the data storage module 110, the status module 112, the read module 114, the decode module 116, the write module 118, and the ML module 122. The status module 112 may be coupled to the data storage module 110, the read module 114, the decode module 116, the write module 118, the control module 120, and the ML module 122. The data storage module 110 may store configuration files associated with the ML module 122 and/or a TVSO selection table, among other examples. A TVSO selection table may be coupled to the read module 114. A TVSO selection table may include one or more indexes and corresponding TVSO values to be used in performing reads (e.g., an index corresponding to a block, a wordline, or a page and TVSO values for each threshold voltage region required to perform a read).

The read module 114 may be coupled to the control module 120, the ML module 122 and the decode module 116. The control module 120 may be coupled to the decode module 116, the ML module 122, and the data storage module 110. The ML module 122 may be coupled to data storage module 110 such that configuration files can be loaded thereon. In some examples, the ML module 122 may include a neural processing module such as, for example, a specialized hardware module (e.g., a specialized configurable accelerator) specifically configured to perform a neural network operation, sometimes referred to as a neural network engine (e.g., a programmable logic circuit). In some examples, the ML module 122 may include firmware (e.g., a processor and software for performing ML operations).

In some implementations, the SSD controller 102 may be an integrated circuit device and some or all of the modules 112, 114, 116, 118, 120, and 122 may include circuits that may be dedicated circuits for performing operations, and some or all of modules 112, 114, 116, 118, 120, and 122 may be firmware that include instructions that are performed on one or more processors for performing operations of the SSD controller 102, with the instructions stored in registers of one or more of modules 112, 114, 116, 118, 120, and 122 and/or stored in the data storage module 110 or the memory device 108. In some embodiments, some of all of modules 112, 114, 116, 118, 120, and 122 may include processors for performing instructions and one or more firmware image may be loaded into the SSD controller 102 (e.g., through the host connector receptacle 106) prior to operation of the SSD controller 102. The firmware image may include instructions to be performed by one or more of modules 112, 114, 116, 118, 120, and 122. Each flash memory device 104 may be a packaged semiconductor die or “chip” that is coupled to the SSD controller 102 by conductive pathways that couple instructions, data, and other information between each flash memory device 104 and the SSD controller 102.

A flash memory device 104 may include a VB 124. The VB 124 is a collection of blocks (e.g., memory blocks) 126 across multiple LUNs 128. A virtual wordline 130 is illustrated as a row of blocks 126. The VB 124 may include multiple channels 132, which may facilitate parallel data transfer operations. Each channel may be connected to multiple targets 134, which in turn are connected to multiple LUNs 128, forming a hierarchical structure that allows for efficient data management and access. In some implementations, a block 126 may refer to a basic unit of erase operations in NAND flash memory. For example, a block may typically contain 128 or 256 pages, with each page capable of storing several kilobytes of data.

The VB 124 may include multiple virtual pages 136. A virtual page 136 is a collection of NAND pages across all LUNs 128 in the VB 124. The number of virtual pages 136 in a VB 124 is equal to the number of pages of a single block 126. In some aspects, a data stripe may be a RAID stripe. In some other aspects, a data stripe may refer to some other portion of data stored on a block.

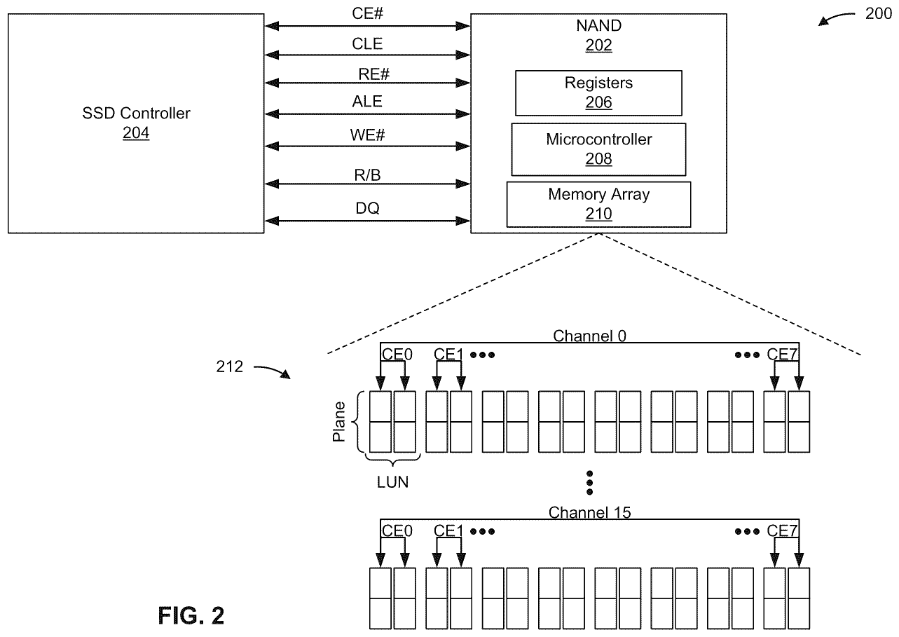

FIG. 2 is a block diagram showing another example of an SSD 200, in accordance with the present disclosure. In the embodiment shown in FIG. 2, a flash memory device 202 (e.g., a NAND device) is coupled to an SSD controller 204. The flash memory device 202 may be, be similar to, include, or be included in, the flash memory device 104 shown in FIG. 1. The SSD controller 204 may be, be similar to, include, or be included in, the SSD controller 102 shown in FIG. 1. The flash memory device 202 includes registers 206, a microcontroller 208, and a memory array 210, and is coupled to the SSD controller 204 by a chip enable signal line (CE #), a command latch enable signal line (CLE), a read enable signal line (RE #), an address latch enable signal line (ALE), a write enable signal line (WE #), a read/busy signal line (R/B) and input and output signal lines (DQ). Upon receiving a write instruction from a host computer, a write module (e.g., the write module 118 shown in FIG. 1) may be operable to encode received data into a codeword that is sent to the registers 206 along with a corresponding program instruction. The microcontroller 208 may be operable to perform the requested program instruction and retrieve the page data from the registers 206 and write the page data into the memory array 210 by programming cells of the memory array 210. The microcontroller 208 may also be operable to erase cells of the memory array 210. During write operation a complete page worth of data is written to the physical WLs.

In one example, the flash memory device 202 may include NAND memory cells that are organized into blocks and pages, with each block composed of NAND strings that share the same group of wordlines. Each virtual page is composed of cells belonging to the same wordline. However, in MLC flash memory devices, multiple virtual pages may correspond with a single wordline. The number of virtual pages within each logical block (or virtual block) is typically a multiple of 16 (e.g. 64, 128). In some embodiments, a virtual page is the smallest addressable unit for reading from, and writing to, the NAND memory cells of the flash memory device 202 and a logical block is the smallest erasable unit. However, it is appreciated that, in various embodiments, programming less than an entire virtual page may be possible, depending on the structure of the NAND array. Though the flash memory device 202 is illustrated as being a NAND device, it is appreciated that the flash memory device 202 may be any type of memory storage device that uses a threshold voltage for reading memory cells of the flash memory device 202. The terms programming and writing are used interchangeably throughout this document.

In some examples, the SSD 200 may include multiple flash memory devices that are similar to the flash memory device 202. The flash memory devices may be SLC, MLC, TLC QLC or PLC NAND devices. In various aspects, the flash memory devices may be capable of performing a wide range of threshold-voltage-shift reads, including reads specified by whole number offset values such as −n . . . −2, −1, 0, +1, +2 . . . n without limitation. A block, of a flash memory device 202 that has been erased and does not contain any programmed data may be referred to as a “free block.” When data is programmed into an erased block, the block is then referred to as an “open block” until all pages of the block have been programmed. Once all pages of the block have been programmed the block is referred to as a “closed block” until it is again erased.

The memory array 210 is organized into multiple channels (Channel 0 to Channel 15 shown in the diagram), with each channel containing multiple chip enables (CEs). Each CE is further divided into LUNs, and each LUN consists of multiple planes. For example, as shown, the memory array 210 may include a VB 212. The VB 212 may span across multiple channels and chip enables (CEs) in the memory array 210. The VB 212 is a logical construct that combines physical blocks from different LUNs and planes across the memory array 210, allowing for efficient management of data across the entire SSD 200.

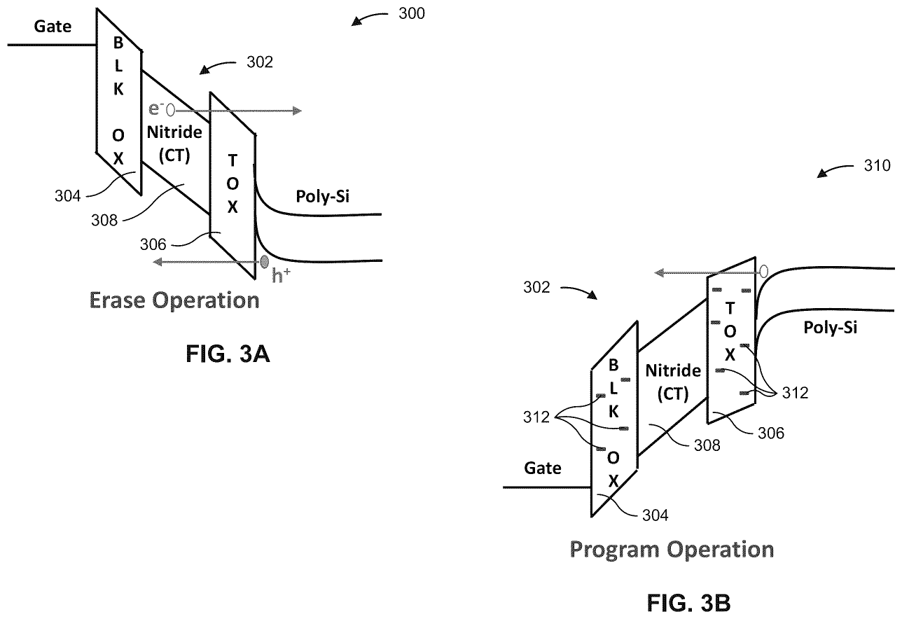

FIGS. 3A and 3B are diagrams that illustrate an impact of erase operations 300 and program operations 310 on NAND cell reliability, in accordance with the present disclosure. FIGS. 3A and 3B depict a memory cell structure 302 and the changes that occur during these operations.

As shown in both of FIGS. 3A and 3B, a memory cell structure 302 includes a block insulating oxide layer 304 (shown as “BLK OX”). The block insulating oxide layer 304 may be positioned at the top of the structure 302 and may serve as an insulating barrier. The memory cell structure 302 also includes a tunnel insulating oxide layer 306 (shown as “TOX”). The tunnel insulating oxide layer 306 may be located at the bottom of the structure 302 and may allow for the tunneling of electrons during erase and program operations. The memory cell structure 302 also includes a charge trap layer 308 (shown as “CT”). The charge trap layer 308 may be composed of a nitride material and may be the location in which charges are stored during programming.

FIG. 3A shows an erase operation 300 in the memory cell structure 302. During the erase operation 300, electrons may move from the charge trap layer 308 through the tunnel insulating oxide layer 306. This process may remove stored charges from the memory cell structure 302, resetting its state.

FIG. 3B depicts a program operation 310 in the same memory cell structure 302. The program operation 310 may involve injecting electrons into the charge trap layer 308. The program operation 310 may change the threshold voltage of the memory cell structure 302 by trapping electrons in the charge trap layer 308. This process may allow the memory cell structure 302 to store information.

Multiple program and erase operations may lead to the formation of oxide traps 312 in the block insulating oxide layer 304 and/or the tunnel insulating oxide layer 306. The oxide traps 312 may be defects or irregularities that form within the block insulating oxide layer 304 and/or the tunnel insulating oxide layer 306 as a result of repeated program and erase cycles. These traps 312 may affect the reliability and performance of the memory cell structure 302 over time. The repeated cycles of erase operations 300 and program operations 310 may gradually degrade the reliability of the NAND cell. The formation of oxide traps 312 may contribute to this degradation by affecting the cell's ability to retain charges and maintain consistent threshold voltages.

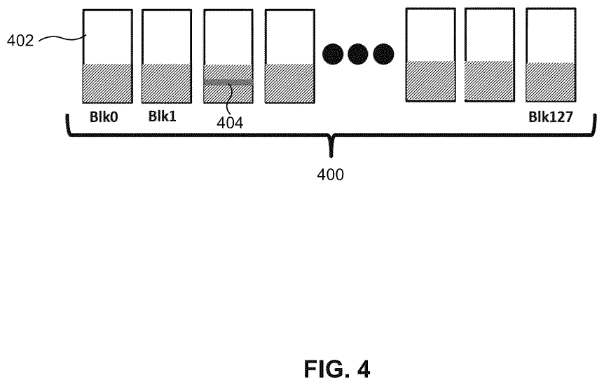

FIG. 4 is a diagram illustrating an example of a read error in a partially-filled VB 400, in accordance with the present disclosure. The VB includes a number of physical blocks 402 (labeled “Blk0,” “Blk1,” . . . “Blk127”). The physical blocks 402 may span different LUNs and/or planes within an SSD (such as, for example, the SSD 200 shown in FIG. 2 and/or the SSD 100 shown in FIG. 1).

The physical blocks 402 are partially shaded, indicating that these blocks 402 contain stored data. The unshaded portions of the physical blocks 402 represent unused or available storage space within the VB 400. This partial filling of the VB 400 illustrates that it may be in an “open” state, where not all pages or blocks 402 have been programmed. A read error 404 is depicted in one of the physical blocks 402. The read error 404 may indicate a specific portion of the block 402 where data cannot be read correctly or reliably. The presence of the read error 404 in a partially-filled VB 400 may highlight the benefit of selective data refresh operations, as described herein. Instead of refreshing the entire VB 400, which may lead to unnecessary write amplification, the SSD may refresh only the affected data stripe or physical block 402 where the read error 404 occurred.

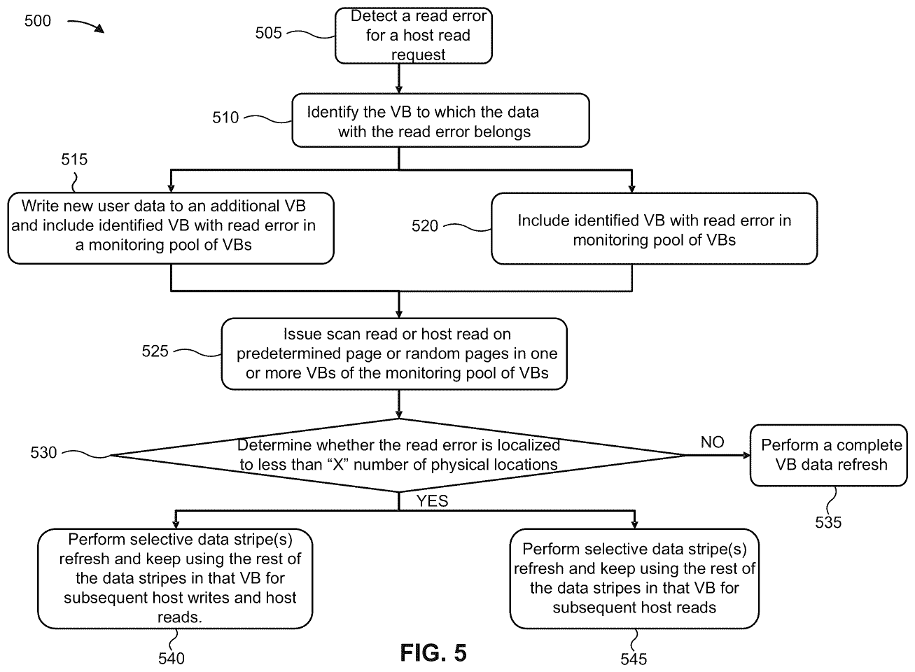

FIG. 5 is a diagram of an example process 500 associated with performing a selective data refresh operation of a data stripe of a VB as described herein as described herein. In some implementations, one or more process blocks of FIG. 5 may be performed by a controller of an SSD such as, for example, the SSD controller 204 shown in FIG. 2 and/or the SSD controller 102 shown in FIG. 1.

As shown in FIG. 5, process 500 may include detecting a read error for a host read request (block 505). For example, a host device may issue a read request. Data may be obtained from a block of a VB based on the read request. In some examples, the data may be subject to decoding failures, thereby causing a read error as a result of the read request.

As shown in FIG. 5, process 500 may include identifying the VB to which the data with the read error belongs (block 510). For example, the controller may identify the VB that stores the data and identify a data frame of the VB that stores the data. The data frame may be included in the block and the data may be included in a data stripe of the block (or a data stripe of the VB). As an example, the data stripe may be a wordline.

As shown in FIG. 5, process 500 may include writing new user data to an additional VB and including the identified VB with read error in a monitoring pool of VBs (block 515). As explained herein, if a VB is an open state, data may be programmed to the VB until all pages or blocks of the VB have been programmed. In this regard, if the identified VB is an open state, the controller may typically continue to program (or write) data to the identified VB until all pages or blocks of the VB have been programmed. The controller may receive the new user data from the host device as part of a request to program the new user data (e.g., as part of a request to continue to program data to the identified VB). However, because the controller has identified the VB as being subjected to the read error, the controller may write the new user data to another VB that is not experiencing a read error. In other words, based on identifying the VB as a VB subjected to the read error, the controller may determine that the new user data is not to be programmed to the identified VB (e.g., to prevent the new user data from being subjected to data loss or data corruption). Accordingly, the controller may identify the other VB as a VB that is not experiencing a read error and may program the new user data to the other VB. The other VB may be an open VB. Additionally, the controller may include the VB in a monitoring pool of VBs that have experienced read errors (e.g., a pool of VBs that are monitored by the controller). In some implementations, the VBs (in the pool of VBs) may be evaluated to determine whether the read errors (experienced by the VBs) are localized to a portion of physical locations of the VBs, as described herein (e.g., in connection with blocks 525 and 530). In other words, the VBs may be evaluated to determine whether the read errors are occurring on a few physical wordlines (e.g., are localized) or the read errors are occurring on an entire block (e.g., are not localized). If the read errors are localized to a portion of the physical locations of a particular VB (e.g., the controller may determine that remaining physical locations of the particular VB may be used for host writes and host reads, as described herein. In this regard, a refresh operation may be performed on the portion of the physical locations without being performed on the remaining physical locations.

As shown in FIG. 5, process 500 may include including the identified VB with read error in the monitoring pool of VBs (block 520). For example, if the identified VB is in a closed state, the controller may include the identified VB in the monitoring pool of VBs, as explained herein (e.g., in connection with block 515). As explained herein, a VB may be in a closed state if all pages or blocks of the VB have been programmed. Accordingly, additional data may not be programmed onto the VB. Therefore, the controller may not receive a request to program additional data onto the identified VB. Accordingly, the controller may include the identified VB in the monitoring pool of VBs without programming the additional data to an additional VB.

As shown in FIG. 5, process 500 may include issuing scan read or host read on predetermined pages or random pages in one or more VBs in the monitoring pool of VBs (block 525). For example, the one or more VBs may include the identified VB. Accordingly, the controller may cause scan read operations or host read operations (or a combination of the operations) to be performed on the identified VB. For example, the controller may cause scan read operations or host read operations (or a combination of the operations) to be performed on predetermined pages of the identified VB or on random pages of the identified VB (or a combination of the pages).

In some situations, a number of scan read operations and host read operations may be specific to the SSD or may be specific to the workload (or combination). Similarly, locations of the scan read operations and the host read operations may be specific to the SSD or may be specific to the workload (or combination). In some situations, Host/Scan read decision may be based on counts of number of read retries before a read status pass (e.g., before a read operation is successful).

As shown in FIG. 5, process 500 may include determining whether the read error is localized to less than a particular number of physical locations in the identified VB (block 530). For example, based on results of the scan read operations and the host read operations, the controller may determine whether the read error is localized to less than a particular number of physical locations in the identified VB. In some situations, the particular number may be based on P/E cycles (e.g., may be a function of P/E cycles). In some examples, the particular number may be stored in a data structure (e.g., a lookup table).

As shown in FIG. 5, process 500 may include performing a complete VB data refresh (block 535). For example, the controller may determine that the read error is not localized to less than the particular number of physical locations in the identified VB. In other words, the controller may determine that the data, causing the read error, is stored in more than the particular number of physical locations. Accordingly, the controller may perform a complete data refresh of the identified VB.

As shown in FIG. 5, process 500 may include performing selective data stripe(s) refresh and keeping using the rest of the data stripes in the VB for subsequent host writes (host write operations) and subsequent host reads (host read operations) (block 540). For example, the controller may determine that the read error is localized to less than the particular number of physical locations in the identified VB. In this regard, if the identified VB is an open state, the controller may determine that the data, causing the error, is stored in a data stripe of the VB (e.g., in a wordline of a block of the identified VB). In this regard, the selective data stripe refresh (or data refresh of the data stripe) may include moving the data to an alternate healthy location (e.g., a separate VB), while the identified VB can remain intact, less the data that has been moved and refreshed to the alternate healthy location. Because the identified VB is in an open state, additional data may be written to the identified VB. Accordingly, the host device may (continue to) provide a request for additional data to be programmed to the identified VB (e.g., a request for subsequent host writes to data stripes other than the data stripe that has been refreshed). Additionally, the host device may provide a request for data to be read from the identified VB (e.g., a request for subsequent host reads of data stripes other than the data stripe that has been refreshed).

As shown in FIG. 5, process 500 may include performing selective data stripe(s) refresh and keep using the rest of the data stripes in that VB for subsequent host reads (block 545). For example, the controller may determine that the read error is localized to less than the particular number of physical locations in the identified VB. In this regard, if the identified VB is in a closed state, the controller may perform a data refresh to move the data stripe to another VB and may keep using the rest of the data stripes in that VB for subsequent host reads. Because the identified VB is in a closed state, subsequent host writes may not be performed on the identified VB.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

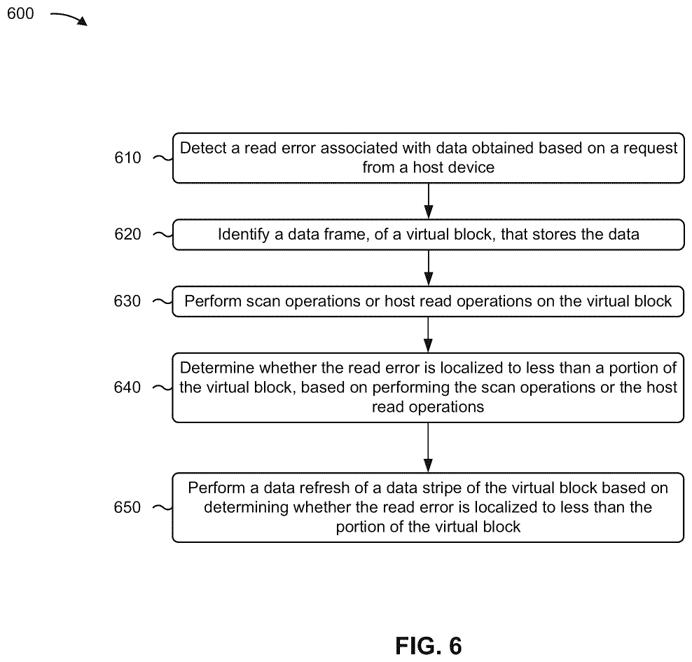

FIG. 6 is a flowchart of an example process 600 associated with mitigating data decoding failures. In some implementations, one or more process blocks of FIG. 6 may be performed by a controller of an SSD such as, for example, the SSD controller 204 shown in FIG. 2 and/or the SSD controller 102 shown in FIG. 1.

As shown in FIG. 6, process 600 may include detecting a read error associated with data obtained based on a request from a host device (block 610). For example, the controller may detect a read error associated with data obtained based on a request from a host device, as described above.

As further shown in FIG. 6, process 600 may include identifying a data frame, of a VB, that stores the data (block 620). For example, the controller may identify a data frame, of a VB, that stores the data, as described above.

As further shown in FIG. 6, process 600 may include performing scan operations or host read operations on the VB (block 630). For example, the controller may perform scan operations or host read operations (or host reads) on the VB, as described above.

As further shown in FIG. 6, process 600 may include determining whether the read error is localized to less than a portion of the VB, based on performing the scan operations or the host read operations (block 640). For example, the controller may determine whether the read error is localized to less than a portion of the VB, based on performing the scan operations or the host read operations, as described above.

As further shown in FIG. 6, process 600 may include performing a data refresh of a data stripe of the VB based on determining whether the read error is localized to less than the portion of the VB (block 650). For example, the controller may perform a data refresh of a data stripe of the VB based on determining whether the read error is localized to less than the portion of the VB, wherein the data stripe includes the data, and wherein the data refresh is performed without performing a data refresh of other data stripes of the VB, as described above. In some implementations, the data stripe includes the data. In some implementations, the data refresh is performed without performing a data refresh of other data stripes of the VB.

In some implementations, process 600 includes including the VB in a pool of VBs that are monitored, and performing the scan operations or the host read operations on the VBs included in the pool of VBs.

In some implementations, process 600 includes determining whether the VB is in an open state or in a closed state, prior to performing the scan operations or the host read operations on the VB, and when the VB is in the open state, performing a write operation (or a host write) to write new user data to a different VB.

In some implementations, process 600 includes determining that the read error is localized to less than the portion of the VB, and performing the data refresh of the data stripe of the VB based on determining that the read error is localized to less than the portion of the VB.

In some implementations, process 600 includes determining that the read error is not localized to less than the portion of the VB, and performing a complete data refresh of the VB based on determining that the read error is not localized to less than the portion of the VB.

In some implementations, process 600 includes determining the portion of the VB based on a number of program/erase cycles associated with the VB.

In some implementations, process 600 includes determining a number of the scan operations or the host read operations based on a storage device that includes the VB, and determining a number of the scan operations or the host read operations based on a workload associated with the storage device.

In some implementations, process 600 includes performing the scan operations or the host read operations based on a number of read retry operations before a read operation is successful.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

In some implementations, a method comprising: detecting a read error associated with data obtained based on a request from a host device; identifying a data frame, of a VB, that stores the data; performing scan operations or host read operations on the VB; determining whether the read error is localized to less than a portion of the VB, based on performing the scan operations or the host read operations; and performing a data refresh of a data stripe of the VB based on determining whether the read error is localized to less than the portion of the VB, wherein the data stripe includes the data, and wherein the data refresh is performed without performing a data refresh of other data stripes of the VB.

In some implementations, a system comprising: a controller to: detect a read error associated with data obtained based on a request from a host device, wherein the data is stored in a VB; perform scan operations or host read operations on the VBs; determine whether the data, associated with the read error, is stored in less than a portion of the VB, based on performing the scan operations or the host read operations; and perform a data refresh of a data stripe of the VB based on determining whether the data is stored in less than the portion of the VB, wherein the portion of the VB includes the data stripe, and wherein the data refresh is performed without performing a data refresh of other data stripes of the VB.

In some implementations, a non-transitory computer-readable medium storing a set of instructions includes one or more instructions that, when executed by one or more processors of a controller, cause the controller to: detect a read error associated with data obtained based on a request from a host device; identify a data frame, of a VB, that stores the data; perform scan operations or host read operations on the VB; determine whether the read error is localized to less than a portion of the VB, based on performing the scan operations or the host read operations; and perform a data refresh of a data stripe of the VB based on determining whether the read error is localized to less than the portion of the VB, wherein the data stripe includes the data, and wherein the data refresh is performed without performing a data refresh of other data stripes of the VB.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems or methods described herein may be implemented in different forms of hardware, firmware, or a combination of hardware and software. The actual control hardware or software code used to implement these systems or methods is not limiting of the implementations. Thus, the operation and behavior of the systems or methods are described herein without reference to specific software code-it being understood that software and hardware can be used to implement the systems or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims or disclosed in the specification, these combinations are not intended to limit the disclosure of various implementations. In fact, many of these features may be combined in ways not specifically recited in the claims or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein is to be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “or,” unless explicitly stated otherwise (e.g., if used in combination with “either” or “only one of”).

What is claimed is:

1. A method comprising:
detecting a read error associated with data obtained based on a request from a host device;
identifying a data frame, of a virtual block, that stores the data;
performing scan operations or host read operations on the virtual block;
determining whether the read error is localized to less than a portion of the virtual block, based on performing the scan operations or the host read operations; and
performing a data refresh of a data stripe of the virtual block based on determining whether the read error is localized to less than the portion of the virtual block,
wherein the data stripe includes the data, and
wherein the data refresh is performed without performing a data refresh of other data stripes of the virtual block.

2. The method of claim 1, comprising:
including the virtual block in a pool of virtual blocks that are monitored; and
performing the scan operations or the host read operations on the virtual blocks included in the pool of virtual blocks.

3. The method of claim 1, comprising:
determining whether the virtual block is in an open state or in a closed state, prior to performing the scan operations or the host read operations on the virtual block; and
when the virtual block is in the open state, performing a write operation to write new user data to a different virtual block.

4. The method of claim 1, comprising:
determining that the read error is localized to less than the portion of the virtual block; and
performing the data refresh of the data stripe of the virtual block based on determining that the read error is localized to less than the portion of the virtual block.

5. The method of claim 1, comprising:
determining that the read error is not localized to less than the portion of the virtual block; and
performing a complete data refresh of the virtual block based on determining that the read error is not localized to less than the portion of the virtual block.

6. The method of claim 1, comprising:
determining the portion of the virtual block based on a number of program/erase cycles associated with the virtual block.

7. The method of claim 1, comprising:
determining a number of the scan operations or the host read operations based on a storage device that includes the virtual block; and
determining the number of the scan operations or the host read operations based on a workload associated with the storage device.

8. The method of claim 7, comprising prior to detecting the read error:
performing the scan operations or the host read operations based on a number of read retry operations before a read operation is successful.

9. A system comprising:
a controller to:
detect a read error associated with data obtained based on a request from a host device,
wherein the data is stored in a virtual block;
perform scan operations or host read operations on the virtual blocks;
determine whether the data, associated with the read error, is stored in less than a portion of the virtual block, based on performing the scan operations or the host read operations; and
perform a data refresh of a data stripe of the virtual block based on determining whether the data is stored in less than the portion of the virtual block,
wherein the portion of the virtual block includes the data stripe, and
wherein the data refresh is performed without performing a data refresh of other data stripes of the virtual block.

10. The system of claim 9, wherein the controller is to:
include the virtual block in a pool of virtual blocks that are monitored; and
perform the scan operations or the host read operations on the virtual blocks included in the pool of virtual blocks.

11. The system of claim 10, wherein the controller is to:
determine whether the virtual block is in an open state or in a closed state, prior to performing the scan operations or the host read operations on the virtual block; and
when the virtual block is in the open state, perform a write operation to write new user data to a different virtual block.

12. The system of claim 11, wherein the controller is to:
determine that the data is stored in less than the portion of the virtual block; and
perform the data refresh of the data stripe of the virtual block based on determining that the data is stored in less than the portion of the virtual block.

13. The system of claim 9, wherein, to perform the read operation, the controller is to:
determine that the data is not stored in less than the portion of the virtual block; and
perform a complete data refresh of the virtual block based on determining that the data is not stored in less than the portion of the virtual block.

14. The system of claim 13, wherein the controller is to:
determine the portion of the virtual block based on a number of program/erase cycles associated with the virtual block.

15. A non-transitory computer-readable medium storing a set of instructions, the set of instructions comprising:
one or more instructions that, when executed by one or more processors of a controller, cause the controller to:
detect a read error associated with data obtained based on a request from a host device;
identify a data frame, of a virtual block, that stores the data;
perform scan operations or host read operations on the virtual block;
determine whether the read error is localized to less than a portion of the virtual block, based on performing the scan operations or the host read operations; and
perform a data refresh of a data stripe of the virtual block based on determining whether the read error is localized to less than the portion of the virtual block,
wherein the data stripe includes the data, and
wherein the data refresh is performed without performing a data refresh of other data stripes of the virtual block.

16. The non-transitory computer-readable medium of claim 15, comprising:
include the virtual block in a pool of virtual blocks that are monitored; and
perform the scan operations or the host read operations on the virtual blocks included in the pool of virtual blocks.

17. The non-transitory computer-readable medium of claim 15, comprising:
determine whether the virtual block is in an open state or in a closed state, prior to performing the scan operations or the host read operations on the virtual block; and
when the virtual block is in the open state, performing a write operation to write new user data to a different virtual block.

18. The non-transitory computer-readable medium of claim 15, comprising:
determine that the read error is localized to less than the portion of the virtual block; and
perform the data refresh of the data stripe of the virtual block based on determining that the read error is localized to less than the portion of the virtual block.

19. The non-transitory computer-readable medium of claim 15, comprising:
determine that the read error is not localized to less than the portion of the virtual block; and
perform a complete data refresh of the virtual block based on determining that the read error is not localized to less than the portion of the virtual block.

20. The non-transitory computer-readable medium of claim 15, comprising:
determine the portion of the virtual block based on a number of program/erase cycles associated with the virtual block; and
determine a number of the scan operations or the host read operations based on a storage device that includes the virtual block.
